(19) United States
(12) Patent Application Publication
(10) Pub. No.: US 2012/0092674 A1
(43) Pub. Date: Apr. 19, 2012

(54) Determination of Electromagnetic Properties of Samples

(75) Inventors: Amin Enayati, Leuven (BE); Steven Brebels, Hechtel-Eksel (BE); Walter De Raedt, Lint (BE); Guy Vandenbosch, Heindonk (Willebroek) (BE)

(73) Assignees: Katholieke Universiteit Leuven, K.U. Leuven R&D, Leuven (BE); IMEC, Leuven (BE)

(21) Appl. No.: 13/272,818

(22) Filed: Oct. 13, 2011

Related U.S. Application Data
(60) Provisional application No. 61/392,725, filed on Oct. 13, 2010.

(51) Int. Cl. G01N 21/55; G01N 21/01

(52) U.S. Cl. 356/445; 356/244

(57) ABSTRACT

Disclosed are methods and devices for measuring electromagnetic properties of samples. In one embodiment, a device is disclosed that includes a substantially two-dimensional measurement chamber comprising a reflective surface, where the reflective surface has a substantially elliptical shape that forms a part of an ellipse having a first focal point and a second focal point. The device further includes an input/output port located at the first focal point and a sample holder located at the second focal point.

### CROSS-REFERENCE TO RELATED APPLICATION

This application is a non-provisional of U.S. Provisional Patent Application Ser. No. 61/392,725 filed Oct. 13, 2010, the contents of which are hereby incorporated by reference.

### BACKGROUND

There are many ways in which electromagnetic properties of materials may be tested. Some of these are non-destructive, such as, for example, the system disclosed in Darling, U.S. Pat. No. 5,574,379. Darling's system allows measurement of the electromagnetic properties of a component. In Darling's system, electromagnetic energy (e.g., microwave energy) is directed towards the component being tested and the reflected energy is analysed to indicate the resistivity or magnetic susceptibility of the component.

Further, there are many ways in which materials may be characterized at millimeter and sub-millimeter frequencies. For example, Aguirre, U.S. Pat. No. 4,507,602 describes a system for measuring the properties of a sample. According to Aguirre, the sample is positioned between two sectoral horns that are placed mouth-to-mouth with the sample in between. An input signal in the Ku band (e.g., 12.4 to 18 GHz) is supplied to the sample via one horn and the transmitted and reflected signals from the sample are received at respective horns. The transmitted and reflected signals are then analysed to determine the complex permittivity and permeability of the sample.

Permittivity measurements may also be performed on printed wiring, circuit boards, thin films and other substrates in order to measure their integrity. This is described by, for example, Baker-Jarvis et al. in “Dielectric Measurements on Printed Wiring and Circuit Boards, Thin Films and Substrates: An Overview”, Mat. Res. Soc. Sympo. Proc., Vol. 381, 1995.

Another way in which electromagnetic properties may be measured is through the use of Fabry-Perot resonators. Fabry-Perot resonators may use microwaves, as described by, for example, R. N. Clarke et al. in “Fabry-Perot and Open Resonators at Microwave and Millimetre Wave Frequencies, 2-300 GTHz”, J. Phys. E: Sci. Instrum., Vol. 15, 1982. Properties that can be measured include dielectric constant, anisotropy, and magnetic resonance.

The measurement of dielectric constants is also described by, for example, T. Zwick et al. in “Determination of the Complex Permittivity of Packaging Materials at Millimeter-Wave Frequencies”, IEEE Trans. Microw. Theory Tech., Vol. 54, no. 3, 2006. Frequencies from below 20 to 100 GHz are used for performing measurements on thin sheet substrate materials.

J. Krupka explains in “Frequency Domain Complex Permittivity Measurements at Microwave Frequencies”, Meas. Sci. Technol., Vol. 17, pages 55 to 70, 2006 that corrugated horn antennas can be used with elliptical surfaces for measuring laminar samples.

Jean et al., U.S. Pat. No. 5,455,516, describe a method and apparatus for the measurement of moisture in a material. According to Jean, microwave energy is coupled to a measurement chamber via a coaxial transmission line over a multi-octave bandwidth via an intermediate microstrip-to-slotline coupling circuit.

However, most of these methods or techniques use samples with large dimensions and tend to be unsuitable for measuring the electromagnetic properties of small samples. In addition, the sample needs to be correctly positioned within a three-dimensional space so that misalignment aberrations do not have an impact on the accuracy of the measurement.

Moreover, known methods and apparatuses tend to be over-complicated for measuring small samples, particularly synthesised materials, such as carbon nanotubes and graphene, where the size of the samples is limited.

### SUMMARY

Disclosed are methods and systems for determining electromagnetic properties of small samples.

The disclosed methods and apparatuses may provide a simplified technique measuring electromagnetic properties of small samples, as compared with typical techniques.

The disclosed methods and systems may additionally allow for the measurement of any material parameter that can be determined from the electromagnetic properties.

The disclosed methods and systems may additionally allow for the measurement of electromagnetic properties at millimeter and sub-millimeter wave frequencies for samples with dimensions in the range of a few millimeters by a few millimeters. Smaller samples are possible as well.

In one aspect, a measurement device is disclosed. The measurement device includes a substantially two-dimensional measurement chamber comprising a reflective surface, where the reflective surface has a substantially elliptical shape that forms a part of an ellipse having a first focal point and a second focal point. The measurement chamber further comprises an input/output port located at the first focal point and a sample holder located at the second focal point.

In some embodiments, the sample holder is configured to hold a sample, the input/output port is configured to transmit an electromagnetic signal towards the reflective surface, the reflective surface is configured to reflect the electromagnetic signal towards the sample, the sample is configured to reflect a reflection of the electromagnetic signal towards the reflective surface, and the reflective surface is configured to reflect the reflection of the electromagnetic signal towards the input/output port. In these embodiments, the measurement device may further include a processor coupled to the input/output port and configured to process the reflection of the electromagnetic signal to measure at least one electromagnetic property. The processor may be coupled to the input/output port via one of a coaxial cable and a waveguide.

In some embodiments, walls of the measurement chamber comprise a material configured to absorb the electromagnetic signal.

In some embodiments, the input/output port comprises at least one of a probe, a waveguide, a loop, an aperture, and an antenna.

In some embodiments, the measurement chamber being substantially two-dimensional comprises the electromagnetic signal having a wavelength and the measurement chamber having a thickness on the order of the wavelength.

In another aspect, a measurement device is disclosed that comprises a substantially two-dimensional measurement chamber comprising a first reflective surface, where the first reflective surface has a substantially elliptical shape that forms a part of a first ellipse having a first focal point and a second focal point. The measurement chamber further comprises a second reflective surface, where the second reflective surface has a substantially elliptical shape that forms a part of a second ellipse having a third focal point and a fourth focal point, where the fourth focal point is coincident with the second focal point. The measurement chamber further comprises a first input/output port located at the first focal point, a second input/output port located at the third focal point, and a sample holder located at the second and fourth focal points.

In some embodiments, the sample holder is configured to hold a sample, the first input/output port is configured to transmit an electromagnetic signal towards the first reflective surface, the first reflective surface is configured to reflect the electromagnetic signal towards the sample, the sample is configured to (i) transmit a transmission of the electromagnetic signal towards the second reflective surface and (ii) reflect a reflection of the electromagnetic signal towards the first reflective surface, the first reflective surface is further configured to reflect the reflection of the electromagnetic signal towards the first input/output port, and the second reflective surface is configured to reflect the transmission of the electromagnetic signal towards the second input/output port.

In some embodiments, the measurement device further comprises a first processor coupled to the first input/output port and configured to process the reflection of the electromagnetic signal to measure at least one electromagnetic property, and a second processor coupled to the second input/output port and configured to process the transmission of the electromagnetic signal to measure at least one electromagnetic property. The first processor may be coupled to the first input/output port via one of a coaxial cable and a waveguide, and the second processor is coupled to the second input/output port via one of a coaxial cable and a waveguide.

In some embodiments, the electromagnetic signal comprises a first electromagnetic signal, the second input/output port is configured to transmit a second electromagnetic signal towards the second reflective surface, the second reflective surface is configured to reflect the second electromagnetic signal towards the sample, the sample is configured to (i) transmit a transmission of the second electromagnetic signal towards the first reflective surface and (ii) reflect a reflection of the second electromagnetic signal towards the second reflective surface, the second reflective surface is further configured to reflect the reflection of the second electromagnetic signal towards the second input/output port, and the first reflective surface is configured to reflect the transmission of the second electromagnetic signal towards the first input/output port. In these embodiments, the first electromagnetic signal may be of a first wavelength and the second electromagnetic signal may be of second wavelength that differs from the first wavelength.

In some embodiments, walls of the measurement chamber comprise a material configured to absorb the electromagnetic signal.

In some embodiments, each of the first input/output port and the second input/output port comprises at least one of a probe, a waveguide, a loop, an aperture, and an antenna.

In some embodiments, the measurement chamber being substantially two-dimensional comprises the electromagnetic signal having a wavelength and the measurement chamber having a thickness on the order of the wavelength.

In yet another aspect, a method is disclosed. The method comprises providing a sample in a substantially two-dimensional measurement chamber, transmitting an electromagnetic signal from an input/output port towards a reflective surface in the measurement chamber, reflecting the electromagnetic signal off the reflective surface towards the sample, reflecting a reflection of the electromagnetic signal off the sample towards the reflective surface, reflecting the reflection of the electromagnetic signal off the reflective surface towards the input/output port and, based on the reflection of the electromagnetic signal, measuring at least one electromagnetic property of the sample.

In some embodiments, the reflective surface comprises a first reflective surface and the input/output port comprises a first input/output port, and the method further comprises transmitting a transmission of the electromagnetic signal off the sample towards a second reflective surface in the measurement chamber, reflecting the transmission of the electromagnetic signal off the second reflective surface towards a second input/output port, and, based on the transmission of the electromagnetic signal, measuring at least one electromagnetic property of the sample.

Further, in some embodiments the electromagnetic signal comprises a first electromagnetic signal, and the method further comprises transmitting a second electromagnetic signal from the second input/output port towards the second reflective surface in the measurement chamber, reflecting the second electromagnetic signal off the second reflective surface towards the sample, reflecting a reflection of the second electromagnetic signal off the sample towards the second reflective surface, transmitting a transmission of the second electromagnetic signal off the sample towards the first reflective surface, reflecting the reflection of the electromagnetic signal off the second reflective surface towards the second input/output port, reflecting the transmission of the electromagnetic signal off the first reflective surface towards the first input/output port and, based on the reflection and the transmission of the second electromagnetic signal, measuring at least one electromagnetic property of the sample. In these embodiments, the first electromagnetic signal may be of a first wavelength and the second electromagnetic signal may be of second wavelength that differs from the first wavelength.

### BRIEF DESCRIPTION OF THE DRAWINGS

For a better understanding of the present invention, reference will now be made, by way of example only, to the accompanying drawings in which:

FIG. 1 is a schematic illustration of an example measurement device, in accordance with an embodiment;

FIG. 2 is a schematic illustration of another example measurement device, in accordance with an embodiment;

FIG. 3 illustrates a radiation field distribution in the example measurement device shown in FIG. 2, in accordance with an embodiment;

FIG. 4 is a perspective illustration of the example measurement device shown in

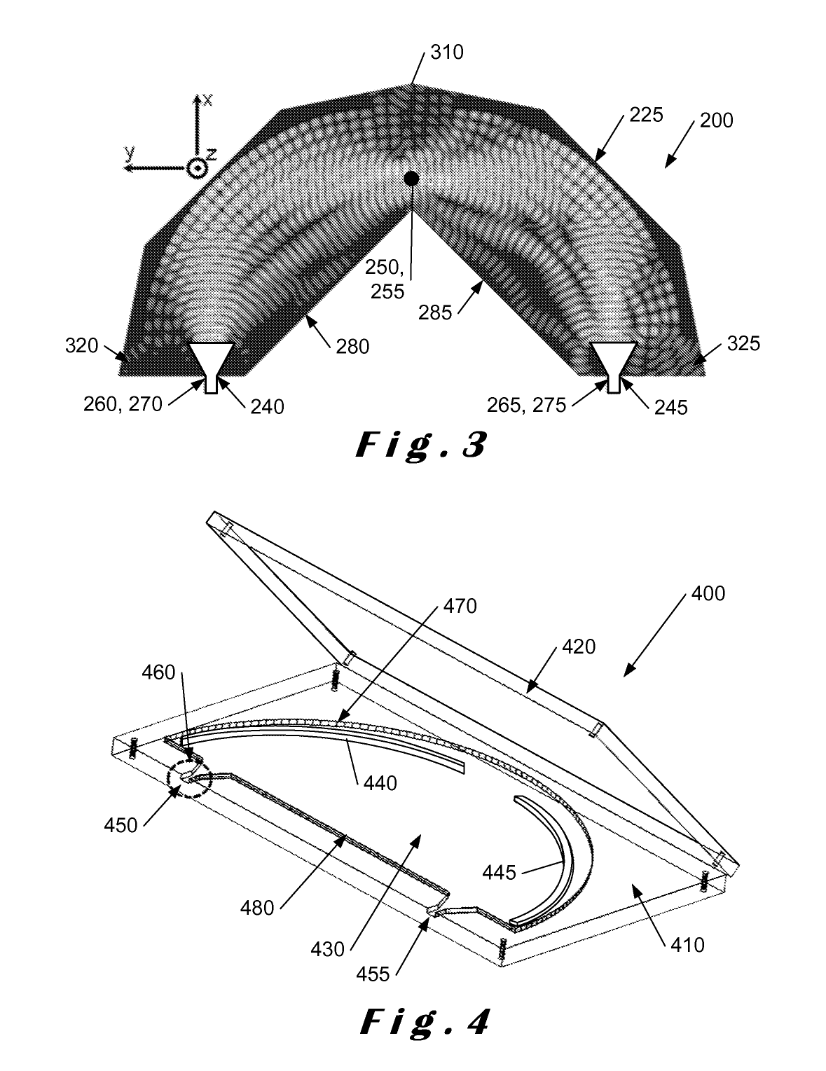

FIG. 2, in accordance with an embodiment;

FIG. 5 is a schematic illustration of another example measurement device, in accordance with an embodiment;

FIG. 6 illustrates a radiation field distribution in the example measurement device shown in FIG. 5, in accordance with an embodiment; and

FIG. 7 illustrates a graph of insertion and return losses as a function of frequency for an example measurement device, in accordance with an embodiment.

### DETAILED DESCRIPTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes.

It will be understood that the terms “vertical” and “horizontal” are used herein refer to particular orientations of the Figures and these terms are not limitations to the specific embodiments described herein.

The terms “first”, “second”, “third” and the like are used in the description for distinguishing between similar elements and not necessarily for describing a sequential or chronological order. It will be appreciated that the terms are interchangeable under appropriate circumstances and that the embodiments of the invention can operate in other sequences than described or illustrated herein if necessary.

While the following description discusses determining particular electromagnetic properties (e.g., electromagnetic permittivity, magnetic permeability, etc.) of samples, it is to be understood that the electromagnetic properties are merely illustrative, and that other electromagnetic properties may be determined as well, as will be understood by the person of ordinary skill in the art.

Further, while the following description discussing determining electromagnetic properties of particular samples (e.g., carbon nanotubes, graphene, etc.), it is to be understood that the samples are merely illustrative, and that electromagnetic properties of other samples may be determined as well, as will be understood by the person of ordinary skill in the art.

Graphene is an allotrope of carbon whose structure is one atom thick planar sheets of bonded carbon atoms densely packed in a honeycomb crystal lattice. The crystalline or “flake” form of graphite consists of many graphene sheets stacked together.

Carbon nanotubes (CNTs) are allotropes of carbon with a cylindrical nanostructure which have unusual properties. Their name is derived from their long hollow structure with walls formed by one atom thick sheets of graphene. The sheets of graphene are rolled at specific and discrete chiral angles to form the CNT, the combination of the rolling angle and the radius of the tube determines the properties of the CNT formed. CNTs are used in many technical areas including, but not limited to, nanotechnology, electronics, and optics.

As used herein, the term “electromagnetic signal” may be understood to refer to an electromagnetic wave within the measurement chamber. The term is also used to refer to the electromagnetic waves that are received for processing.

Disclosed is a device for the measurement of electromagnetic properties of small samples of synthesized materials using a two-dimensional geometry. Because the disclosed device uses a two-dimensional geometry, the device eases the alignment requirements typical of devices using a three-dimensional geometry.

The disclosed device comprises a measurement chamber and an input/output port. The input/output port serves to transmit electromagnetic signals into the measurement chamber. The electromagnetic signals are reflected off of a sample inside the measurement chamber to produce reflected electromagnetic signals. The input/output port further serves to receive the reflected electromagnetic signals from the measurement chamber. The input/output port may include an antenna coupled to the measurement chamber through which the electromagnetic signals are channeled for both transmission and reception. Alternately, the input/output port may include any of probes, waveguides, loops, antennas, apertures or other suitable structures.

The electromagnetic signals transmitted by the input/output port may be controlled through a controllable source of electromagnetic energy. The controllable source may, for example, allow for selection of a frequency of the electromagnetic signals. The controllable source may be coupled to the input/output port.

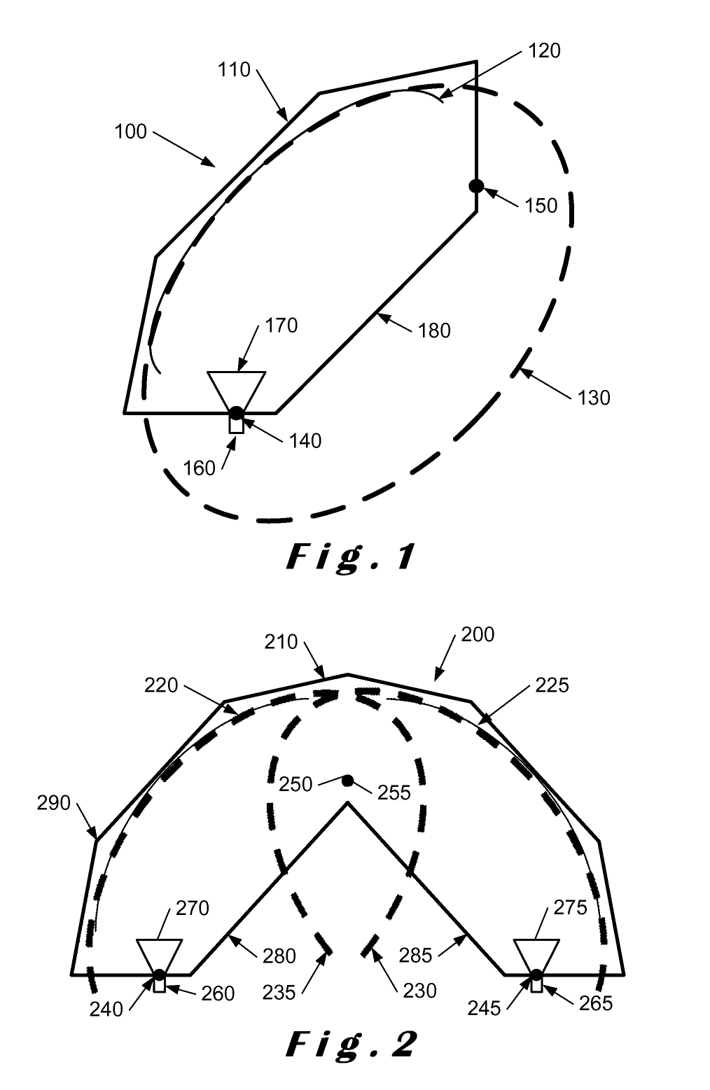

FIG. 1 is a schematic illustration of an example measurement device 100, in accordance with an embodiment. As shown, the device 100 comprises a closed measurement chamber 110 that is shaped as an irregular hexagon. The measurement chamber 110 is constructed as a substantially two-dimensional chamber. To this end, the thickness or depth of the measurement chamber 110 may be, for example, on the order of the wavelength of the electromagnetic radiation used, which may be in the range of, for example, millimeter or sub-millimeter frequencies.

As shown, the measurement chamber 110 includes a reflective surface 120 having an at least partly conic shape. In this embodiment, the conic shape results from the substantially elliptical reflective surface 120. Electromagnetic signals directed into the measurement chamber 110 may reflect off the reflective surface 120 onto a sample provided in the measurement chamber. Further, electromagnetic signals directed out of the measurement chamber 110 may reflect off the reflective surface 120 out of the measurement chamber 110.

The substantially elliptical reflective surface 120 may form part of an ellipse 130, as indicated by the dotted line. As shown, the ellipse 130 is a regular ellipse having a first focal point 140 and a second focal point 150. An input/output port 160 may be positioned at the first focal point 140. As shown, the input/output port 160 includes an antenna 170 through which electromagnetic signals may be coupled into and out of the measurement chamber 110. Further, a sample holder (not shown) for holding the sample may be positioned at the second focal point 150.

The electromagnetic signals coupled into the measurement chamber 110 may be reflected off the reflective surface 120 towards the sample. Further, the electromagnetic signals may be reflected off the sample back towards the reflective surface 120, and may reflect off the reflective surface 120 towards the input/output port 160. At the input/output port 160, the electromagnetic signals reflected off the sample may be coupled out of the measurement chamber 110 using the antenna 170 and may be passed to a processor (not shown) for processing. Based on the electromagnetic signals reflected off the sample, the processor may determine the permittivity and the permeability of the sample.

The processor may comprise a network analyser and a computer that is connected to the input/output port 140 via a waveguide or a coaxial cable. In some embodiments, the processor may also control the generation of the electromagnetic signals that are coupled into the measurement chamber 110.

In some embodiments, wall 180 of the measurement chamber 110 may be covered by electromagnetic absorbing material (not shown) that prevents interference between electromagnetic signals reflected from the walls of the measurement chamber 110 and the electromagnetic signals reflected from the sample. In this way, electromagnetic signals incident on the wall 180 of the measurement chamber 110 are not reflected, but rather are absorbed so that only the electromagnetic signals reflected from the sample in the sample holder (not shown) are received at the input/output port 160 via the antenna 170.

FIG. 2 is a schematic illustration of another example measurement device 200, in accordance with an embodiment. As shown, the measurement device 200 includes a measurement chamber 210. The measurement chamber 210 may be a substantially two-dimensional measurement chamber. Further, as shown, the measurement chamber 210 may comprise a first reflective surface 220 and a second reflective surface 225. Each of the first and second reflective surfaces 220, 225 may be substantially elliptical. The first reflective surface 220 may form a part of a first ellipse 230, while the second reflective surface 225 may form a part of a second ellipse 235. As shown, the first ellipse 230 has a first focal point 240 and a second focal point 250. Similarly, the second ellipse 235 has a third focal point 245 and a fourth focal point 255. The second focal point 250 and the fourth focal point 255 are coincident.

The measurement device 200 further includes a first input/output port 260 and a second input/output port 265. The first input/output port 260 includes an antenna 270 and is located at the first focal point 240. The second input/output port 265 includes an antenna 275 and is located at the third focal point 245. Each of the first and second input/output ports 260, 265 may be connected to a waveguide and/or a coaxial cable (not shown) at the outside of the measurement device 200.

The measurement device further includes a sample holder, which may be positioned at the coincident second and fourth focal points 250, 255.

The measurement chamber 210 is defined by walls 280, 285 and the elliptical surfaces 220, 225. In particular, as shown, the walls 280, 285 form part of a housing 290 that is shaped to accommodate the elliptical surfaces 220, 225. In some embodiments, the walls 280, 285 may be covered with electromagnetic absorbing material (not shown) to prevent electromagnetic signals reflected from the walls 280, 285 from interfering with electromagnetic signals reflected from and transmitted through the sample.

In operation, an electromagnetic signal is coupled into the measurement chamber 210 by the antenna 270 at the first input/output port 260. The electromagnetic signal is directed towards the first reflective surface 220. The electromagnetic signal is then reflected off of the first reflective surface 220 towards the sample in the sample holder at the coincident second and fourth focal points 250, 255. Electromagnetic signals that pass through the sample are reflected off of the second reflective surface 225 towards the antenna 275 at the second input/output port 265. Similarly, electromagnetic signals that are reflected off of the sample are in turn reflected off of the first reflective surface 220 towards the antenna 270 at the first input/output port 260.

Each of the first and second input/output ports 260, 265 is connected to a processor (not shown), such as a network analyzer and a computer, by means of a waveguide and/or coaxial cable (not shown). Based on the electromagnetic signals that passed through the sample, and the electromagnetic signals reflected off the sample, the processors may determine the permittivity and the permeability of the sample. In some embodiments, the processors may also control the generation of the electromagnetic signals that are coupled into the measurement chamber 210.

In some embodiments, the electromagnetic signal may alternatively be coupled into the measurement chamber 210 by the antenna 275 at the second input/output port 270. In these embodiments, the electromagnetic signal is directed towards the second reflective surface 225. The electromagnetic signal is then reflected off of the second reflective surface 220 towards the sample in the sample holder at the coincident second and fourth focal points 250, 255. Electromagnetic signals that pass through the sample are reflected off of the first reflective surface 220 towards the antenna 270 at the first input/output port 260. Similarly, electromagnetic signals that are reflected off of the sample are in turn reflected off of the second reflective surface 225 towards the antenna 275 at the second input/output port 265.

Further, in some embodiments, electromagnetic signals may be coupled into the measurement chamber 210 by both the antenna 270 at the first input/output port 260 and the antenna 275 at the second input/output port 270. For example, electromagnetic signals may be coupled into the measurement chamber 210 by the antennas 270, 275 substantially simultaneously, or sequentially. In some embodiments, the electromagnetic signals coupled into the measurement chamber 210 by the antennas 270, 275 may have different frequencies.

As noted above, the sample holder holding the sample may be placed at the coincident second and fourth focal points 250, 255. The coincident second and fourth focal points 250, 255 may act as an energy source and radiate electromagnetic signals towards the antennas 270, 275.

Scattering parameters (S-parameters) may be (e.g., continuously) measured at one or both of the first and second input/output ports 260, 265. In some embodiments, insertion loss and return loss may be measured. Insertion loss is an expression of the magnitude of the transmission coefficient |S21| in dB and return loss is an expression of the magnitude of the reflection coefficient |S11| in dB. The insertion loss may, for example, be measured to be less than 1 dB for the microwave V band (e.g., between 50 and 75 GHz). Similarly, the return loss may, for example, be measured to be less than 10 dB for the microwave V band.

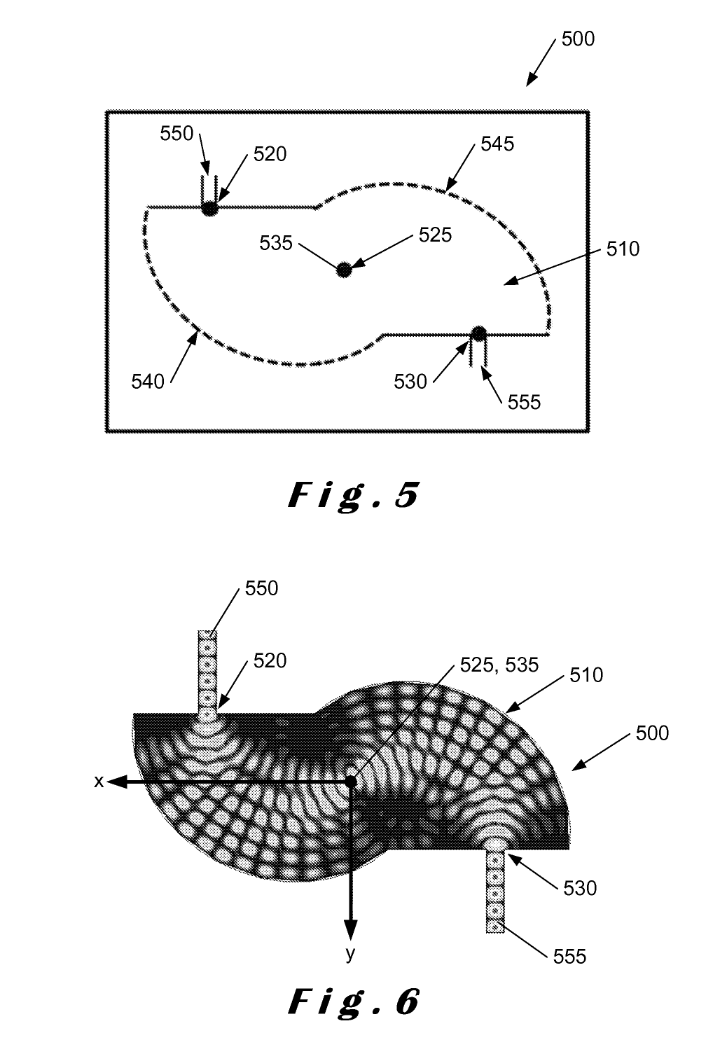

FIG. 3 illustrates a radiation field distribution in the example measurement device 200 shown in FIG. 2, in accordance with an embodiment. As shown in FIG. 3, the antennas 270, 275 comprise H-plane horn antennas that radiate electromagnetic signals towards the first and second reflective surfaces 220, 225, respectively. The horn antennas 270, 275 are implemented in a semi-two-dimensional configuration in an x-y plane such that the electromagnetic signals are confined in the z-direction, resulting in a reduced loss due to diffraction. The electromagnetic signal radiated by the first horn antenna 270 is reflected first off the first reflective surface 220 and then off the second reflective surface 225 before being received by the second horn antenna 275.

As shown, the horn antenna 270 is placed at the first focal point 240 and the horn antenna 275 is placed at the third focal point 245. As a result, the electromagnetic signals radiated by the horn antennas 270, 275 are focused at the coincident second and fourth focal points 250, 255. This focusing may allow the measurement device 210 to have increased sensitivity to the electromagnetic properties of the sample.

In the measurement device 210, the electromagnetic signals may be confined by the first and second reflective surfaces 220, 225 and the walls 208, 285 of the housing 290. Minor leaking may occur through a gap 310 between the first and second reflective surfaces 220, 225 and around the ends 320, 325 of the first and second reflective surfaces 220, 225 adjacent to the first and third focal points 240, 245. In some embodiments, the walls 280, 285 may be covered in electromagnetic absorbing material so that the walls 208, 285 do not reflect any electromagnetic signals in the measurement chamber 210.

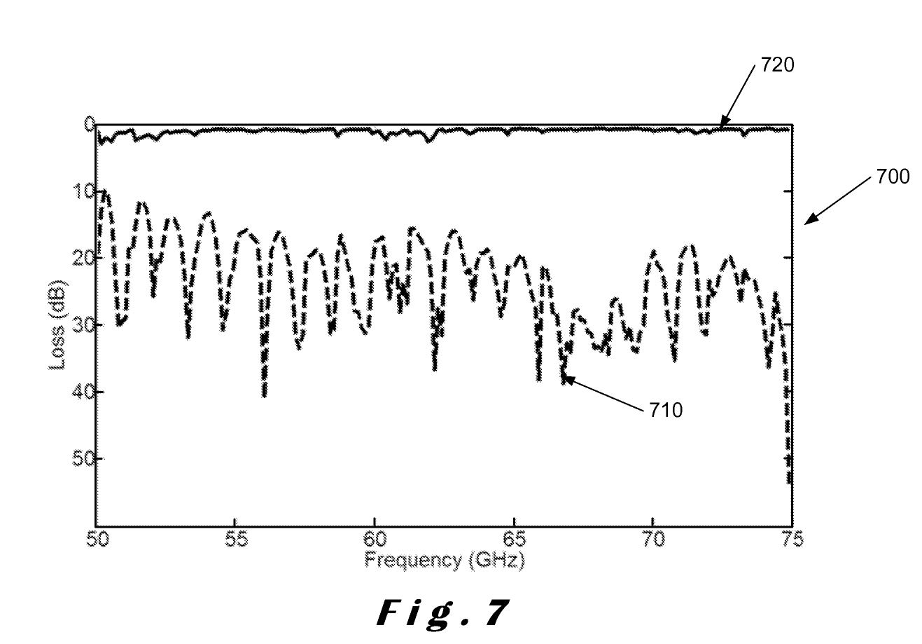

FIG. 4 is a perspective illustration of the example measurement device shown in FIG. 2, in accordance with an embodiment. As shown, the measurement device 400 includes a base portion 410 and a top portion 420 that define a measurement chamber 430. The base portion may have dimensions on the order of, for example, 10 centimeters by 20 centimeters, and may be formed of, for example, aluminum, brass, or silicon with a metallised interior. The height of the measurement chamber 430 may be on the order of, for example, about 2 mm, thereby providing a substantially two-dimensional arrangement at the microwave V band. The top portion 420 may comprise a substantially planar metallic cap sized to be the same as the dimensions of the base portion 410. Other dimensions and other materials are possible as well.

The base portion 410 is shaped to provide a generally semicircular recess that defines the measurement chamber 430. First and second reflective surfaces 440, 445 are provided as shown together with first and second input/output ports 450, 455. The first and second reflective surfaces 440, 445 may be substantially elliptical.

As in the above example measurement devices, the first and second reflective surfaces 440, 445 may each form a part of ellipses. The ellipses may have one coincident focal point and may each have one non-coincident focal point. The first and second input/output ports 450, 455 may be located at the non-coincident focal points of the ellipses.

In the embodiment shown in FIG. 4, the first and second input/output ports 450, 455 may be configured to connect to standard waveguides such as, for example, the WR15 waveguide 460 shown, or any other waveguide suitable for use in the microwave V band.

In order to avoid unwanted resonances from the edges of the measurement chamber 430, absorbers 470, 480 may be placed along the substantially semicircular recess that defines the measurement chamber 430. The first and second input/output ports 450, 455 may be left clear. Such absorbers may comprise, for example, carbon or a graphite-based material.

As in the above example measurement devices, a sample holder for holding a sample may be placed at the coincident focal point of the ellipses. The coincident focal point may act as an energy source to radiate electromagnetic signals towards the first and second input/output ports 450, 455.

FIG. 5 is a schematic illustration of another example measurement device 500, in accordance with an embodiment. As shown, the measurement device 500 comprises a measurement chamber 510 comprising two ellipses (not shown). The first ellipse has a first focal point 520 and a second focal point 525, while the second ellipse has a third focal point 530 and a fourth focal point 535. The second and fourth focal points 525, 535 are coincident, while the first and third focal points 520, 530 are non-coincident.

A portion of each ellipse forms a substantially elliptical reflective surface 540, 545 that reflects electromagnetic signals onto a sample holder (not shown) placed at the coincident second and fourth focal points 525, 535.

The measurement device 500 further comprises first and second input/output ports 550, 555 arranged to be connected to a waveguide or coaxial cable (not shown) at the outside of the measurement chamber 510 and to two open-ended waveguides (not shown) directed towards the measurement chamber 510. As shown, the first input/output port 550 is placed at the first focal point 520, and the second input/output port 555 is placed at the third focal point 530. That is, the first and second input/output ports 550, 555 are placed at the non-coincident first and third focal points 520, 530.

In operation, a sample may be placed in the sample holder at the coincident second and fourth focal points 525, 535, and the first input/output port 550 and/or the second input/output port 555 may transmit an electromagnetic signal into the measurement chamber 510. The coincident second and fourth focal points 525, 535 may act as an additional energy source and radiate electromagnetic signals towards the first and second input/output ports 550, 555.

FIG. 6 illustrates a radiation field distribution in the example measurement device shown in FIG. 5, in accordance with an embodiment. As shown, the field distribution is bounded by the measurement chamber 510. The electromagnetic signals transmitted by the first and second input/output ports 550, 555 are shown to focus at the coincident second and fourth focal points 525, 535.

FIG. 7 illustrates a graph 700 of insertion and return losses as a function of frequency for an example measurement device, in accordance with an embodiment. Return loss is indicated by dotted profile 710 and insertion loss is indicated by solid line 720. As will be apparent to the person of ordinary skill in the art, the insertion and return loss may be used to determine electromagnetic properties of the sample. In this manner, return loss may be optimized.

Although the present invention has been described with reference to specific embodiments, it will be appreciated that other configurations of measurement devices are possible provided there is an overlapping focal point which can be determined from the surface geometry of the elliptical surfaces.

What is claimed is:

1. A measurement device comprising:
a substantially two-dimensional measurement chamber comprising:
a reflective surface, wherein the reflective surface has a substantially elliptical shape that forms a part of an ellipse having a first focal point and a second focal point;
an input/output port located at the first focal point; and
a sample holder located at the second focal point.

2. The measurement device of claim 1, wherein:
the sample holder is configured to hold a sample;
the input/output port is configured to transmit an electromagnetic signal towards the reflective surface;
the reflective surface is configured to reflect the electromagnetic signal towards the sample;
the sample is configured to reflect a reflection of the electromagnetic signal towards the reflective surface; and
the reflective surface is configured to reflect the reflection of the electromagnetic signal towards the input/output port.

3. The measurement device of claim 2, further comprising a processor coupled to the input/output port and configured to process the reflection of the electromagnetic signal to measure at least one electromagnetic property.

4. The measurement device of claim 3, wherein the processor is coupled to the input/output port via one of a coaxial cable and a waveguide.

5. The measurement device of claim 1, wherein walls of the measurement chamber comprise a material configured to absorb the electromagnetic signal.

6. The measurement device of claim 1, wherein the input/output port comprises at least one of a probe, a waveguide, a loop, an aperture, and an antenna.

7. The measurement device of claim 1, wherein the measurement chamber being substantially two-dimensional comprises:
the electromagnetic signal having a wavelength; and
the measurement chamber having a thickness on the order of the wavelength.

8. A measurement device comprising:
a substantially two-dimensional measurement chamber comprising:
a first reflective surface, wherein the first reflective surface has a substantially elliptical shape that forms a part of a first ellipse having a first focal point and a second focal point;
a second reflective surface, wherein the second reflective surface has a substantially elliptical shape that forms a part of a second ellipse having a third focal point and a fourth focal point, wherein the fourth focal point is coincident with the second focal point;
a first input/output port located at the first focal point;
a second input/output port located at the third focal point; and
a sample holder located at the second and fourth focal points.

9. The measurement device of claim 8, wherein:
the sample holder is configured to hold a sample;
the first input/output port is configured to transmit an electromagnetic signal towards the first reflective surface;
the first reflective surface is configured to reflect the electromagnetic signal towards the sample;
the sample is configured to (i) transmit a transmission of the electromagnetic signal towards the second reflective surface and (ii) reflect a reflection of the electromagnetic signal towards the first reflective surface;
the first reflective surface is further configured to reflect the reflection of the electromagnetic signal towards the first input/output port; and
the second reflective surface is configured to reflect the transmission of the electromagnetic signal towards the second input/output port.

10. The measurement device of claim 9, further comprising:
a first processor coupled to the first input/output port and configured to process the reflection of the electromagnetic signal to measure at least one electromagnetic property; and
a second processor coupled to the second input/output port and configured to process the transmission of the electromagnetic signal to measure at least one electromagnetic property.

11. The measurement device of claim 10, wherein:
the first processor is coupled to the first input/output port via one of a coaxial cable and a waveguide; and
the second processor is coupled to the second input/output port via one of a coaxial cable and a waveguide.

12. The measurement device of claim 9, wherein:
the electromagnetic signal comprises a first electromagnetic signal;
the second input/output port is configured to transmit a second electromagnetic signal towards the second reflective surface;
the second reflective surface is configured to reflect the second electromagnetic signal towards the sample;
the sample is configured to (i) transmit a transmission of the second electromagnetic signal towards the first reflective surface and (ii) reflect a reflection of the second electromagnetic signal towards the second reflective surface;
the second reflective surface is further configured to reflect the reflection of the second electromagnetic signal towards the second input/output port; and
the first reflective surface is configured to reflect the transmission of the second electromagnetic signal towards the first input/output port.

13. The measurement device of claim 12, wherein the first electromagnetic signal is of a first wavelength and the second electromagnetic signal is of second wavelength that differs from the first wavelength.

14. The measurement device of claim 8, wherein walls of the measurement chamber comprise a material configured to absorb the electromagnetic signal.

15. The measurement device of claim 8, wherein each of the first input/output port and the second input/output port comprises at least one of a probe, a waveguide, a loop, an aperture, and an antenna.

16. The measurement device of claim 8, wherein the measurement chamber being substantially two-dimensional comprises:
the electromagnetic signal having a wavelength; and
the measurement chamber having a thickness on the order of the wavelength.

17. A method comprising:
providing a sample in a substantially two-dimensional measurement chamber;
transmitting an electromagnetic signal from an input/output port towards a reflective surface in the measurement chamber;
reflecting the electromagnetic signal off the reflective surface towards the sample;
reflecting a reflection of the electromagnetic signal off the sample towards the reflective surface;
reflecting the reflection of the electromagnetic signal off the reflective surface towards the input/output port;
based on the reflection of the electromagnetic signal, measuring at least one electromagnetic property of the sample.

18. The method of claim 17, wherein the reflective surface comprises a first reflective surface and the input/output port comprises a first input/output port, the method further comprising:
transmitting a transmission of the electromagnetic signal off the sample towards a second reflective surface in the measurement chamber;
reflecting the transmission of the electromagnetic signal off the second reflective surface towards a second input/output port; and
based on the transmission of the electromagnetic signal, measuring at least one electromagnetic property of the sample.

19. The method of claim 18, wherein the electromagnetic signal comprises a first electromagnetic signal, the method further comprising:
transmitting a second electromagnetic signal from the second input/output port towards the second reflective surface in the measurement chamber;
reflecting the second electromagnetic signal off the second reflective surface towards the sample;
reflecting a reflection of the second electromagnetic signal off the sample towards the second reflective surface;
transmitting a transmission of the second electromagnetic signal off the sample towards the first reflective surface;
reflecting the reflection of the electromagnetic signal off the second reflective surface towards the second input/output port;
reflecting the transmission of the electromagnetic signal off the first reflective surface towards the first input/output port; and
based on the reflection and the transmission of the second electromagnetic signal, measuring at least one electromagnetic property of the sample.

20. The method of claim 19, wherein the first electromagnetic signal is of a first wavelength and the second electromagnetic signal is of second wavelength that differs from the first wavelength.
